(19) United States
(12) Patent Application Publication
(10) Pub. No.: US 2009/0265534 A1
(43) Pub. Date: Oct. 22, 2009

(54) Fairness, Performance, and Livelock Assessment Using a Loop Manager With Comparative Parallel Looping

(76) Inventors: Duane A. Averill, Rochester, MN (US); Anthony D. Drumm, Rochester, MN (US); Christopher T. Phan, Rochester, MN (US); Brian T. Vanderpool, Byron, MN (US); Sharon D. Vincent, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 12/104,638

(22) Filed: Apr. 17, 2008

(51) Int. Cl. G06F 9/30

(52) U.S. Cl. 712/241; 712/E09.016

(57) ABSTRACT

A method, apparatus, and computer program are provided for assessing fairness, performance, and livelock in a logic development process utilizing comparative parallel looping. Multiple loop macros are generated, the multiple loop macros respectively correspond to multiple processor threads, and the multiple loop macros are parallel comparative loop macros. The multiple processor threads for the multiple loop macros are executed in which a common resource is accessed. A forward performance of each of the multiple processor threads is verified. The forward performance of the multiple processor threads is compared with each other. It is determined whether any of the multiple processor threads fails to meet a minimum loop count or a minimum loop time. It is determined whether any of the multiple processor threads exceeds a maximum loop count or a maximum loop time. It is recognized whether fairness is maintained during the execution of the multiple processor threads.

### TRADEMARKS

IBM ® is a registered trademark of International Business Machines Corporation, Armonk, N.Y., U.S.A. Other names used herein may be registered trademarks, trademarks or product names of International Business Machines Corporation or other companies.

### BACKGROUND

1. Field of the Invention

Exemplary embodiments relate to a method, apparatus, and computer program produced for integrated circuit (IC) function verification, and more particularly, to integrating fairness, performance, and livelock assessment into multiple stages of logic development processes using a loop manager with comparative parallel looping.

2. Description of Background

In large scale, multi-processor cache coherent systems, there exists a significant potential for livelock scenarios in which forward progress in a system is impeded due to one or more processors in the system being unfairly locked out or starved. This lack of fairness can lead to machine check hard errors as one or more threads within the system are unable to complete an operation within a specified period of time. However, in other situations, this type of problem can lead to degraded performance that often goes undetected until the logic is integrated into system-level or performance testing.

In the past, timeout constraints were used in the simulation environment to detect fairness, performance, and livelock problems that would cause the first type of failure identified above (timeouts in the system). However, because of the fact that the number of commands that can be executed within a given simulation is limited and that all drivers in the environment will eventually stop issuing commands, the commands or drivers that are being unfairly locked out or starved will eventually complete and will very often not cause a timeout in simulation. Therefore, the use of timeout constraints did not identify fairness, performance, and livelock problems that caused timeouts in more complicated environments nor did the use of timeouts identify problems that would cause the second type of problem, degraded performance, in which timeouts do not always occur but overall system performance is adversely impacted. In addition, in the past, there has been no means of easily integrating livelock, performance, and fairness testing into simulation environments to effectively verify and tune the livelock prevention circuitry built into the hardware and ensure the threshold counters within this logic are initialized with proper values.

There is a need for the detection and elimination of these types of problems early in the logic development process during simulation and early hardware bringup. There is also a need for a means to effectively tune and verify livelock prevention circuitry in the logic design.

### SUMMARY

In accordance with exemplary embodiments, a method is provided for assessing fairness, performance, and livelock in a logic development process utilizing comparative parallel looping. Multiple loop macros are generated, where the multiple loop macros respectively correspond to multiple processor threads, and where the multiple loop macros are parallel comparative loop macros. The multiple processor threads for the multiple loop macros are executed, where the multiple processor threads are executed to access a common resource. A forward performance of each of the multiple processor threads is verified. The forward performance of each of the multiple processor threads is compared with each other. It is determined whether any of the multiple processor threads fails to meet a minimum loop count or a minimum loop time. It is determined whether any of the multiple processor threads exceeds a maximum loop count or a maximum loop time. It is recognized whether fairness is maintained during the execution of the multiple processor threads.

In accordance with exemplary embodiments, an apparatus is provided for assessing fairness, performance, and livelock in a logic development process utilizing comparative parallel looping. The apparatus includes memory, a processor functionally coupled to the memory, a manager configured to manage multiple loop macros, and multiple bus functional models, each respectively associated with the multiple loop macros. The multiple bus functional models respectively execute the multiple loop macros as the manager monitors the execution. The manager is configured to verify a forward performance of each of the multiple loop macros being executed by the plurality of bus functional models and to compare the forward performance of each of the plurality of loop macros with each other. The manager is configured to determine whether any of the multiple loop macros fails to meet a minimum loop count or a minimum loop time and to determine whether any of the multiple loop macros exceeds a maximum loop count or a maximum loop time. Also, the manager is configured to recognize whether fairness is maintained during the execution of the multiple loop macros.

In accordance with exemplary embodiment, a computer program product tangibly embodied on a computer readable medium is provided for assessing fairness, performance, and livelock in a logic development process utilizing comparative parallel looping. The computer program product including instructions for causing a computer to execute the above method.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features of exemplary embodiments are apparent from the following detailed description taken in conjunction with the accompanying drawings in which:

FIG. 1 illustrates an example of a loop macro being introduced into a simulation environment through the use of either a testcase port or a random parameter file in accordance with exemplary embodiments;

FIG. 2 illustrates an example of using time-based loop commands to assess fairness across N processors in a simulation environment in accordance with exemplary embodiments;

FIG. 3 illustrates how a comparative looping mechanism may operate in a random simulation environment in accordance with exemplary embodiments;

FIG. 4 is a flow chart to illustrate how a comparative looping mechanism may operate in a random simulation environment in accordance with exemplary embodiments;

FIG. 5 is a flow chart that illustrates a procedure for quiescing all loops in the simulation environment in cases where premature termination of the simulation is required or to simulate Hot Plug testing in accordance with exemplary embodiments;

FIG. 6 is a block diagram that represents a comparative parallel loop architecture in accordance with exemplary embodiments;

FIG. 7 illustrates parameters in TABLE 1;

FIG. 8 illustrates parameters in TABLE 2;

FIG. 9 illustrates parameters in TABLE 3;

FIG. 10 illustrates parameters in TABLE 4A;

FIG. 11 illustrates parameters in TABLE 4B;

FIG. 12 illustrates a method for assessing fairness, performance, and livelock in a logic development process utilizing comparative parallel looping in accordance with exemplary embodiments;

FIG. 13 illustrates an example of a computer having capabilities, which may be included in exemplary embodiments.

The detailed description explains exemplary embodiments of the invention, together with advantages and features, by way of example with reference to the drawings.

### DETAILED DESCRIPTION OF EXEMPLARY EMBODIMENTS

Exemplary embodiments provide a mechanism for integrating fairness, performance, and livelock assessment into multiple stages of the logic development process. Rather than using timeout constraints, as was used in the past, exemplary embodiments may use a loop manager with comparative parallel looping within the simulation and bringup environments to both identify and eliminate fairness, performance, and livelock problems as well as to tune and verify livelock circuitry in the hardware to more effectively address these problems. The advantages of this approach include (1) being able to detect fairness, performance, and livelock problems that would lead to degraded system performance and/or timeouts early in the logic development process and (2) being able to verify and tune livelock prevention circuitry in the hardware early in the logic development process. A further advantage provided by this disclosure is a mechanism whereby the detection and verification can be easily integrated into a simulation testcase language, parameter file, or software exerciser used in, e.g., lab bringup.

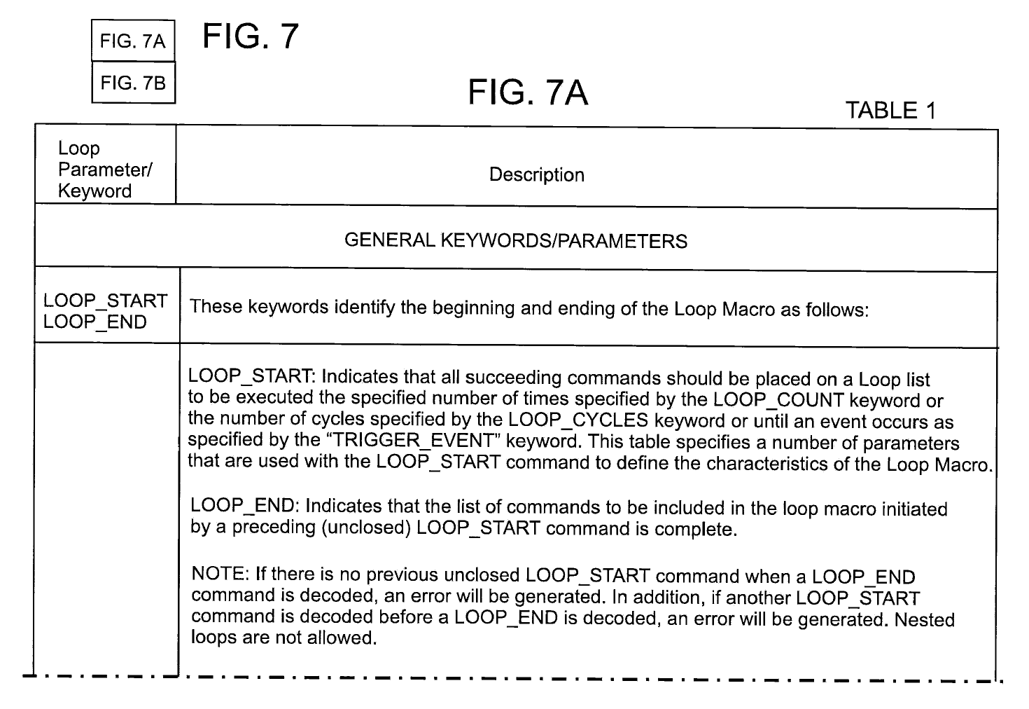

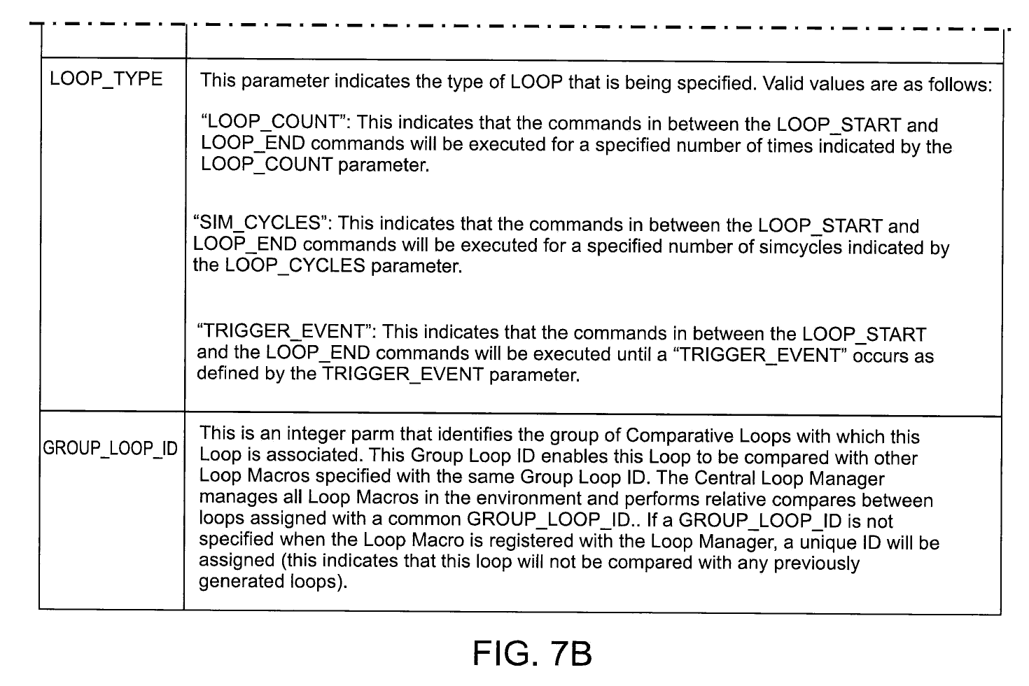

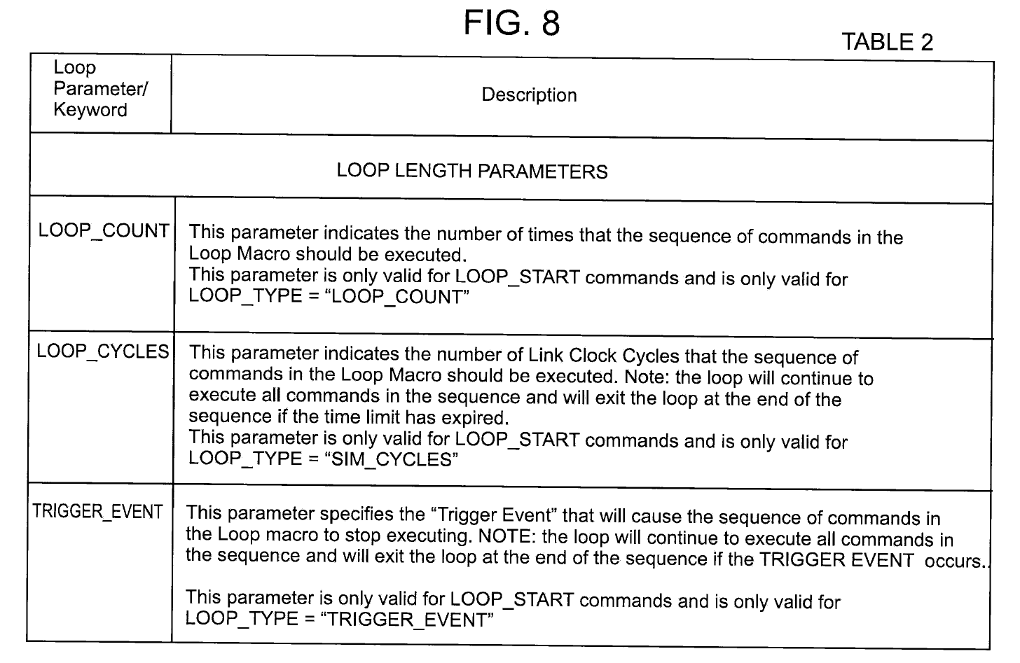

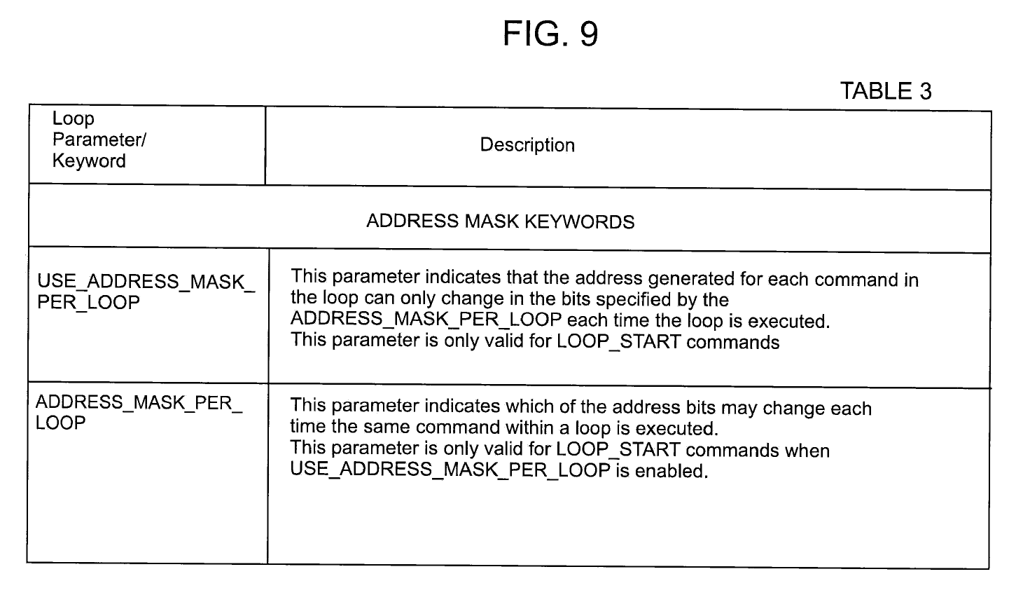

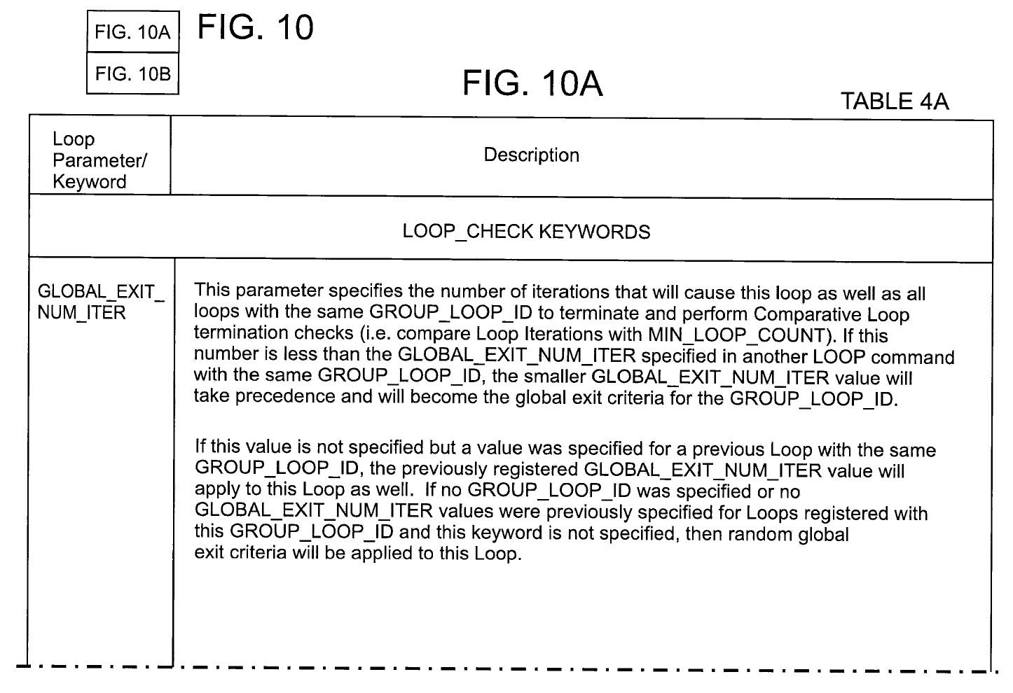

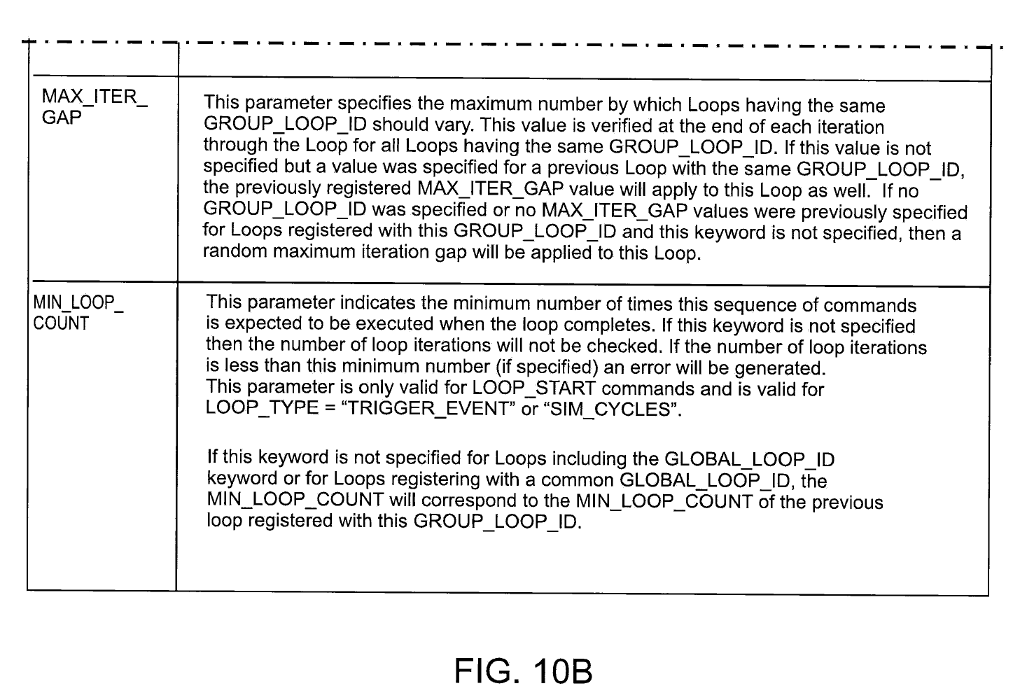

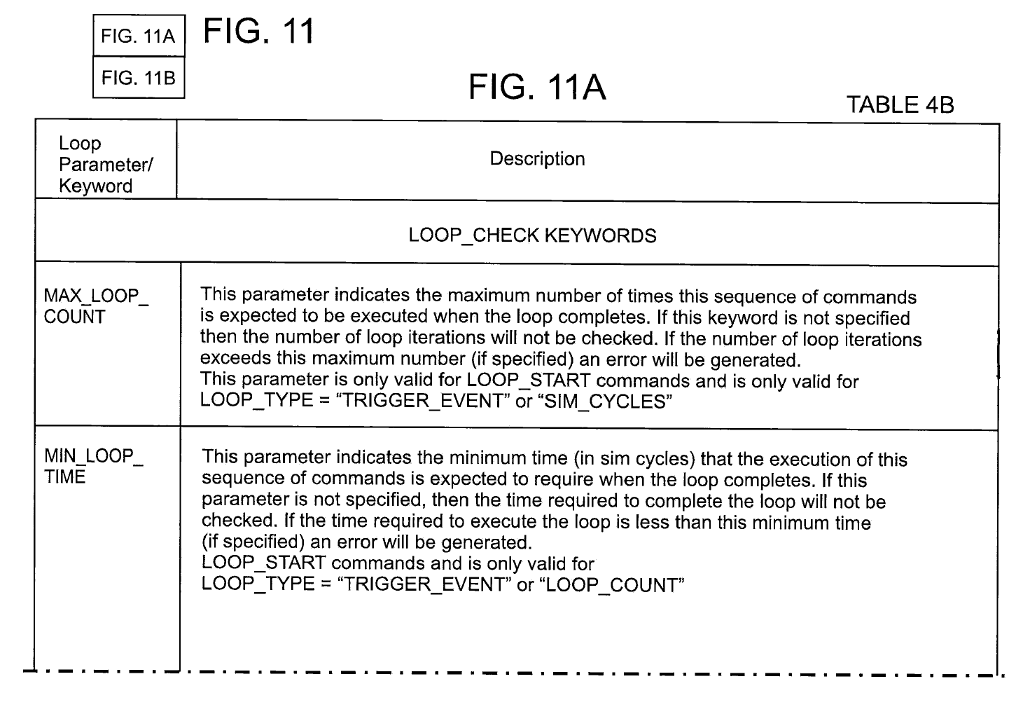

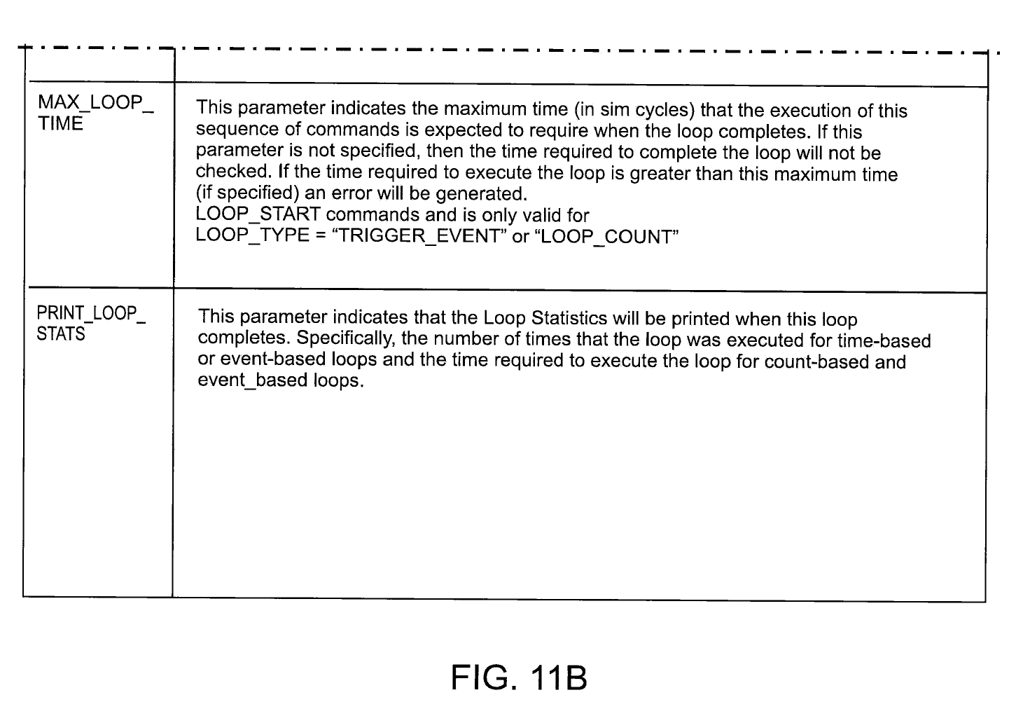

In accordance with exemplary embodiments, parallel comparative loop macros may be used to specify a sequence of commands that can be executed by a specific processor for a specified number of times, for a specified number of clock cycles, or until a specified trigger event occurs. The loop macro is integrated into the simulation stimulus language or random parameter definitions and can be introduced into the simulation environment through the use of a testcase port or parameter file in accordance with exemplary embodiments. The loop macro may also be incorporated into a lab bringup software exerciser as a subroutine or function call. A central loop manager manages all loop macros in the environment. Each bus functional model (BFM) that is capable of interpreting and generating loop macros is registered with the central loop manager at the beginning of simulation. In addition, each loop macro is registered with the central loop manager in the simulation environment and can be specified with a group loop ID to enable the loop macro to be compared with other loop macros specified with the same group loop ID. The central loop manager manages all loop macros in the environment and performs relative comparisons between loops assigned with a common GROUP_LOOP_ID. The GROUP_LOOP_ID is defined in the loop parameter syntax illustrated in TABLES 1, 2, 3, 4A, and 4B of FIGS. 7-11, respectively. If a GROUP_LOOP_ID is not specified when the loop macro is registered with the loop manager, a unique ID will be assigned (this indicates that this loop will not be compared with any previously generated loops).

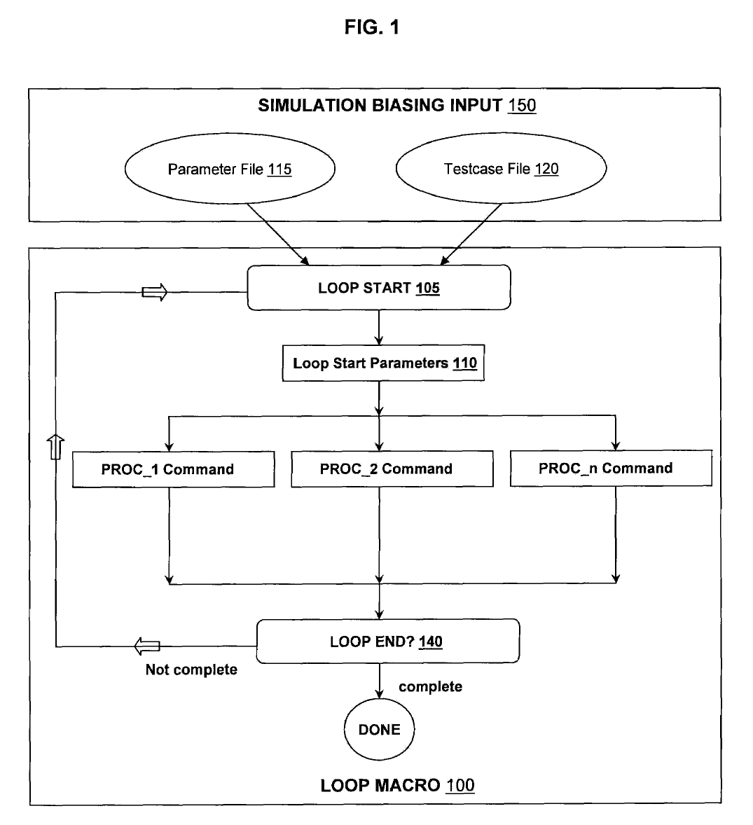

FIG. 1 illustrates an example of a loop macro 100 being introduced into a simulation environment through the use of either a testcase port or a random parameter file in accordance with exemplary embodiments. Also, loop macros 100 may be generated by a BFM in exemplary embodiments. The loop starts at 105. As shown in FIG. 1, the loop macro 100 may consist of a set of LOOP_START parameters 110, or parameters that characterize the nature of the loop. The LOOP_START parameters 110 may be input from a simulation biasing input 150. The simulation biasing input 150 may include testcase files 120 or random parameter files 115.

The loop macro 100 includes a list of commands 130 (PROC_1, PROC_2, PROC_n) that will be executed as part of the loop (i.e., executing reads/writes/requests for cacheline ownership, etc.). Each one of the lists 130 (PROC_1, PROC_2, PROC_n) includes a list of commands to execute for a single processor. The LOOP_END identifier 140 closes the loop and defines the end of the loop macro 100. For example, for loop macros that are generated from testcase files 120, the LOOP_END identifier 140 may be supplied in the testcase file 120 and will indicate the end of the loop macro. For loop macros that are generated from random parameter files 115, the loop is closed according to the loop parameters used to construct the loop (e.g., supplied in the parameter file 115). For example, if the random parameter file 120 indicated that a loop with 15 instructions was to be generated, the loop would close after the generation of the 15^{th} instruction.

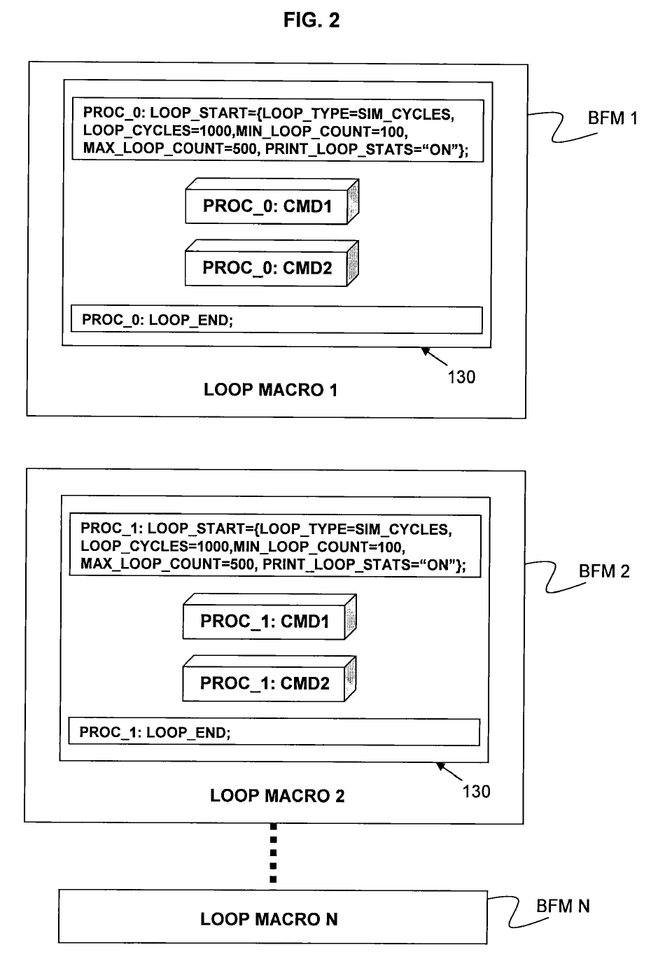

FIG. 2 illustrates an example of using time-based loop commands to assess fairness across N processors in a simulation environment in accordance with exemplary embodiments. FIG. 2 illustrates the contents of loop macros in terms of instructions that can then be interpreted by a series of bus functional models that model the various processors in the simulation environment. The simulation biasing input 150 may be utilized to provide loop commands for each processor in the simulation environment. BFM 1, BFM 2, and BFM N may represent multiple processors. In the simulation biasing input 150, the testcase files 120 or random parameter files 115 may specify or generate loop macros (such as Loop Macro 1, Loop Macro 2, and Loop Macro N), for one or more bus functional models (e.g., BFM 1, BFM 2, and BFM N) in the simulation environment. BFM 1, BFM 2, and BFM N may then respectively execute the loop macro 1, loop macro 2, and loop macro N by driving the commands 130 according to the manner specified by the loop.

As non-limiting examples of commands that may be utilized in the commands 130, FIGS. 7-11 respectively illustrate TABLES 1, 2, 3, 4A, and 4B which list various types of looping parameters that may be specified or randomized for loop macros, e.g., utilizing testcase files 120 or random parameter files 115.

As illustrated in TABLES 1-4B, the loop macros can be time-based, count-based, or trigger event-based loop macros (see description of LOOP_TYPE in TABLE 1). In addition, by creating separate loops for all processor threads in the simulation environment and using the MIN_LOOP_COUNT, MAX_LOOP_COUNT, MIN_LOOP_TIME, and MAX_LOOP_TIME parameters, the forward progress of each processor thread can be verified. For example, if processor loops are set up for each processor thread as shown in FIG. 2, and the commands (such as the commands 130) within the loop macro were similar, if the MIN_LOOP_COUNT was not satisfied by one of the processor threads at the completion of the loops, this would indicate the presence of unfairness that could potentially lead to performance degradation and livelock. Similar scenarios for measuring relative performance between processor threads could be created using the loop macro syntax defined in TABLES 1-4B. For Example, if processor loops were set up for each processor thread as shown in FIG. 2, if the commands (such as the list of commands 130) were similar, if the MIN_LOOP_TIME, MAX_LOOP_COUNT, or MAX_LOOP_TIME was not satisfied by one of the processor threads at the completion of the loops, this would indicate that one or more of the processor threads was receiving an unfair advantage (time to execute the processor loop was lower than the MIN_LOOP_TIME or number of iterations exceeded MAX_LOOP_COUNT) or was being unfairly disadvantaged (time to execute the processor loop was larger than the MAX_LOOP_TIME). In addition, enabling the PRINT_LOOP_STATS parameter in the loop macros would allow designers to review the relative performance of the various threads executed in a testcase (such as the testcase file 120) and to readily identify any unfairness or inconsistencies that would lead to performance degradation or livelock. The loop macro syntax also includes a GROUP_LOOP_ID parameter that allows a specific loop to be associated with other loops that are constructed in the environment. These group loop IDs can be used by the central loop manager to perform relative comparisons and management of multiple loops within the environment.

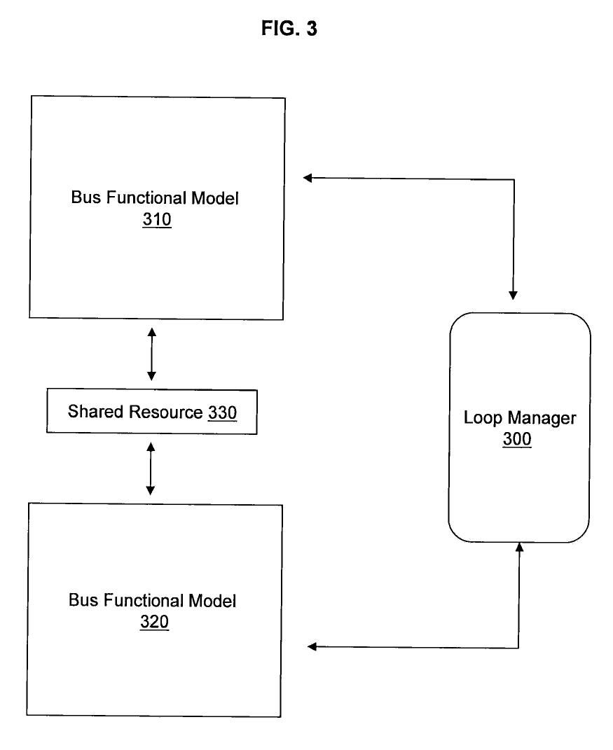

FIG. 3 illustrates how the comparative looping mechanism may operate in a random simulation environment in accordance with exemplary embodiments. A loop manager 300 may be operatively connected to BFM 310 and BFM 320. BFM 310 and 320 are in communication with a resource 330. The resource 330 may represent a hardware or software resource. For example, the resource 330 may be a register, cache, hard drive, etc that is needed to execute loop macros.

As illustrated in FIG. 3, in a random generation environment, the loop manager 300 may randomly direct all registered BFMs (e.g., BFM 310 and BFM 320) to generate random loop macros with a common GROUP_LOOP_ID, Loop length (number of commands in the loop), LOOP COUNT (number of iterations to perform for the loop), GLOBAL_EXIT_NUM_ITER and/or MIN_LOOP_COUNT (minimum number of required iterations when loop is terminated). The BFM 310 and BFM 320 may use the common GROUP_LOOP_ID when registering the resulting loop macro with the loop manager 300, which will allow all loops generated in this way to be compared. Although BFM 310 and 320 are illustrated, it is contemplated that a plurality of BFMs may be used. Also, although the resource 330 is illustrated, it is understood that a plurality of resources may be used.

When one of the loop macros with a specific GROUP_LOOP_ID reaches the GLOBAL_EXIT_NUM_ITER value, the loop manager 300 can verify whether all other loops with the same GROUP_LOOP_ID have reached the MIN_LOOP_COUNT number of iterations, and the loop manager 300 can optionally direct all loops with this GROUP_LOOP_ID to terminate at the completion of the current iteration. A benefit of having the loop manager 300 configured to terminate all loops at the current iteration is that relative performance comparisons would only be valid as long as all processor threads were executing and competing for the same shared resource. For example, if the loops were configured to assess relative performance and fairness, the point at which one of the loops has reached a maximum loop count (and therefore has stopped execution) would be the point at which this relative evaluation could be made. After this point, the system would no longer include maximum contention with respect to the shared resources and there would be no need to continue the execution of the remaining loops.

The loop manager 300 may also use the MAX_ITER_GAP parameter to indicate the maximum discrepancy between current total iterations that can exist between all loops with a common Group ID. The MAX_ITER_GAP parameter may be checked each time a loop macro in the group completes or as each loop macro for BFM 310 and BFM 320 informs the loop manager 300 that an iteration has completed. For example, an iteration may be defined as the completion of one loop count.

The loop manager 300 monitors all loops with common Group IDs and verifies fairness by ensuring that the number of iterations processed by each loop does not vary more than the MAX_ITER_GAP value. This enables livelock, fairness, and performance assessment to be performed on the fly for randomly generated environments.

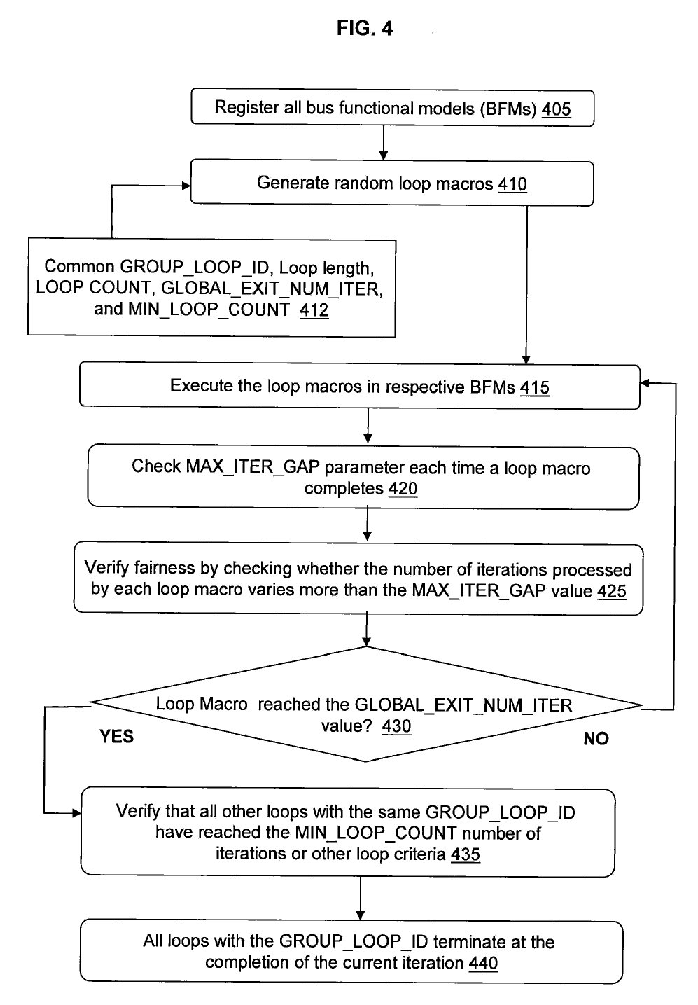

FIG. 4 is a flow chart to illustrate how the comparative looping mechanism may operate in a random simulation environment in accordance with exemplary embodiments. The loop manager 300 may register all BFMs at 405. The loop manager 300 may randomly direct all registered BFMs to generate random loop macros at 410. The loop manager 300 may specify that the loop macros should have a common GROUP_LOOP_ID, Loop length (number of commands in the loop), LOOP COUNT (number of iterations to perform for the loop), GLOBAL_EXIT_NUM_ITER and MIN_LOOP_COUNT (minimum number of required iterations when loop is terminated) at 412. All BFMs use the common GROUP_LOOP_ID when registering the resulting loop macros with the loop manager 300, which will allow all loops generated in this way to be compared.

The loop macros are executed by the respective BFMs at 415. The MAX_ITER_GAP parameter may be checked each time a loop macro in the group completes and/or as each loop macro informs the loop manager 300 that an iteration has completed at 420. The loop manager 300 monitors all loops with common Group IDs and verifies fairness by ensuring that the number of iterations processed by each loop does not vary more than the MAX_ITER_GAP value at 425. The loop manager 300 may determine whether one of the loops with the specific GROUP_LOOP_ID has reached the GLOBAL_EXIT_NUM_ITER value (or any other predefined parameter) at 430. If the loop macros have not reached the GLOBAL_EXIT_NUM_ITER value, the process returns to operation 415. In response to one of the loops with a specific GROUP_LOOP_ID reaching the GLOBAL_EXIT_NUM_ITER value (or any other predefined parameter), the loop manager 300 may verify whether all other loops with the same GROUP_LOOP_ID have reached the MIN_LOOP_COUNT number of iterations or have satisfied other loop criteria (MAX_LOOP_COUNT, MIN_LOOP_TIME, etc.) at 435. The loop manager 300 may direct all loops with this Loop ID to terminate at the completion of the current iteration at 440.

The loop manager 300 may also use the MAX_ITER_GAP parameter to indicate the maximum discrepancy between current total iterations that can exist between all loops with a common Group ID. Further, in response to one of the loop macros meeting a specific constraint (such as GLOBAL_EXIT_NUM_ITER), the loop manager 300 can stop the other loops. As discussed herein, this enables livelock, fairness, and performance assessment to be performed on the fly for randomly generated environments.

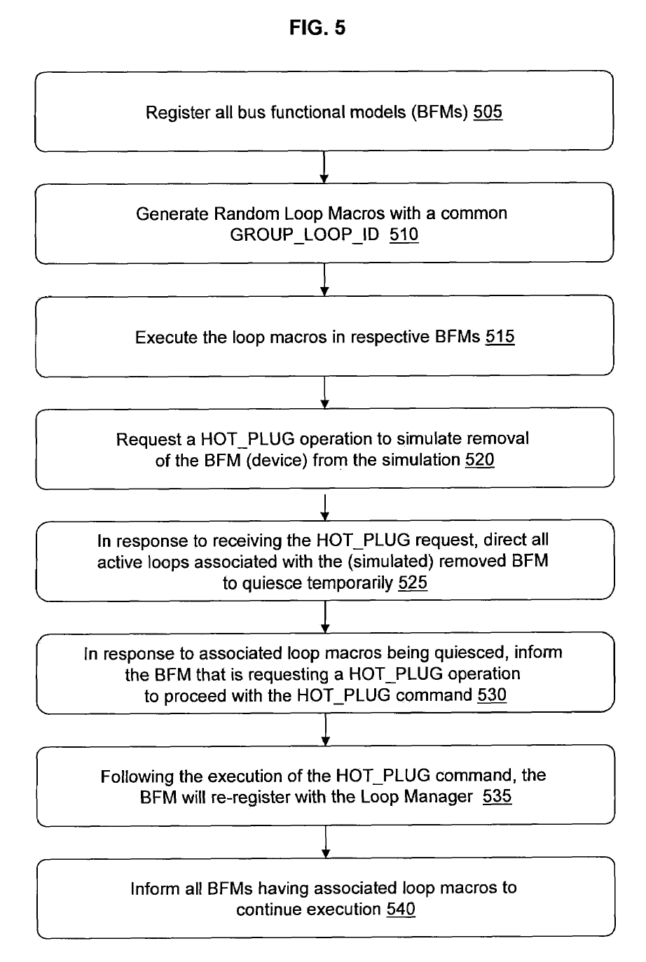

FIG. 5 is a flow chart that illustrates a procedure for quiescing all loops in the simulation environment in cases where premature termination of the simulation is required or to simulate Hot Plug testing in accordance with exemplary embodiments. BFMs are registered at 505. All registered BFMs are directed to generate random loop macros with a common GROUP_LOOP_ID (as in FIG. 3) at 510. The BFMs execute their respective generated loop macros at 515. One of the registered BFMs may request (to the loop manager 300) a HOT_PLUG operation to simulate removal of the device from the simulation at 520. In response to receiving the HOT_PLUG request, the loop manager 300 may direct all active loops with which this BFM is associated to quiesce temporarily at 525. For example, the loop manager 300 may direct all registered BFMs that have loop macros with the same common GROUP_LOOP_ID to quiesce temporarily.

After all associated loop macros have quiesced, the loop manager 300 will inform the BFM that is requesting a HOT_PLUG operation that it can proceed with the HOT_PLUG command at 530. Following the execution of the HOT_PLUG operation, the BFM will re-register with the loop manager 300 at 535, and the loop manager 300 will inform all BFMs having associated loop macros to continue execution at 540. Exemplary embodiments allow for the HOT_PLUG process, which is a common system requirement in which a system can be temporarily quiesced and reconfigured with different memory or operative characteristics. Measuring relative fairness and livelock in the midst of this type of operation is provided in accordance with exemplary.

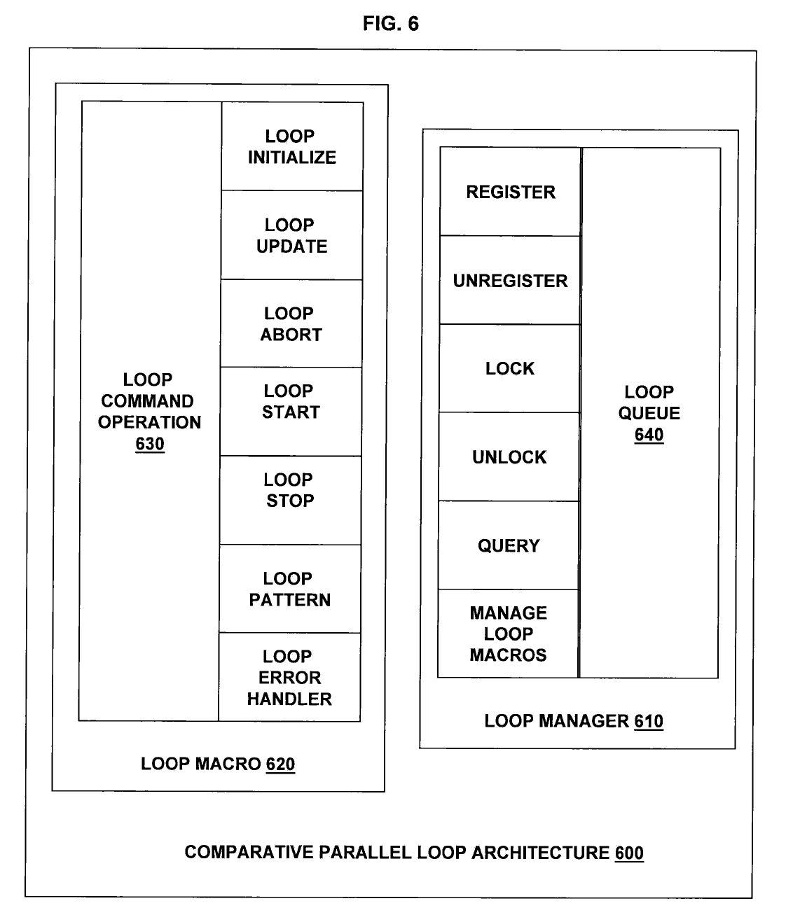

FIG. 6 is a block diagram that represents a comparative parallel loop architecture 600 in accordance with exemplary embodiments. The comparative parallel loop architecture 600 illustrates a loop manager 610 and a loop macro 620.

As shown by FIG. 6, the loop macro 620 includes a list of specific commands in a command operation block 630 which may be executed as part of the loop as well as a list of generic functions that allow the loop macro 620 to interface with the loop manager 610. It should be noted that only the list of internal commands themselves would vary with the type of BFM. Examples of internal commands include read/write commands to main memory, read/write commands to I/O memory or registers, configuration read/write commands, etc. All other components and interface functions between the loop macro 620 and loop manager 610 would be common across all types of BFMs in the Environment.

The loop macro 620 functions of the loop command operation 630 may include among others: loop initialize functions to initialize the parameters of the loop, loop update functions to update the loop manager 610 as the loop progresses, loop abort functions to prematurely terminate the loop, loop start/stop functions to start and stop the loop, loop pattern functions to set up the type of loop pattern to follow, and a loop error handler to handle errors during loop operation.

The loop manager 630 contains the loop queue 640 or list of active loops in the simulation environment as well as associated functions for managing this loop queue 640. The associated functions for managing this loop queue 640 may include among others: register/unregister functions to both register BFMs and loops macros (such as loop macro 620) associated with BFMs, lock/unlock functions to allow BFMs to have sole access to specific resources (such as the resource 330) or addresses in the environment for a period of time, query functions to query the status of active loops, and management functions to manage the execution (e.g., quiesce, abort, generate) of loops in the environment.

In accordance with exemplary embodiments, by integrating this looping mechanism within the simulation environment through the use of parameter files or testcase files as shown in FIG. 1 and using the parameters defined in Tables 1-4B, multiple livelock scenarios may be generated easily, and livelock prevention circuitry within hardware can be adjusted and optimized for maximum system performance and fairness. For example, using the loop parameters in Tables 1-4B, a number of different types of parallel loops may be initiated among all processor BFMs in a system through the use of a testcase port or a random parameter file. These loops may direct all processor BFMs to perform accesses (i.e. reads/writes) to common shared memory, registers, or other resources. If a livelock situation existed within the system, the use of the performance parameters described previously and in Tables 1-4B (i.e., MIN_LOOP_COUNT, MAX_LOOP_COUNT, MAX_ITER_GAP) would identify the livelock situation as described herein.

In addition, by integrating the looping mechanism and loop manager described herein within a subroutine of a software exerciser during lab bringup, livelock verification can be performed quickly and fairness and performance can be assessed early.

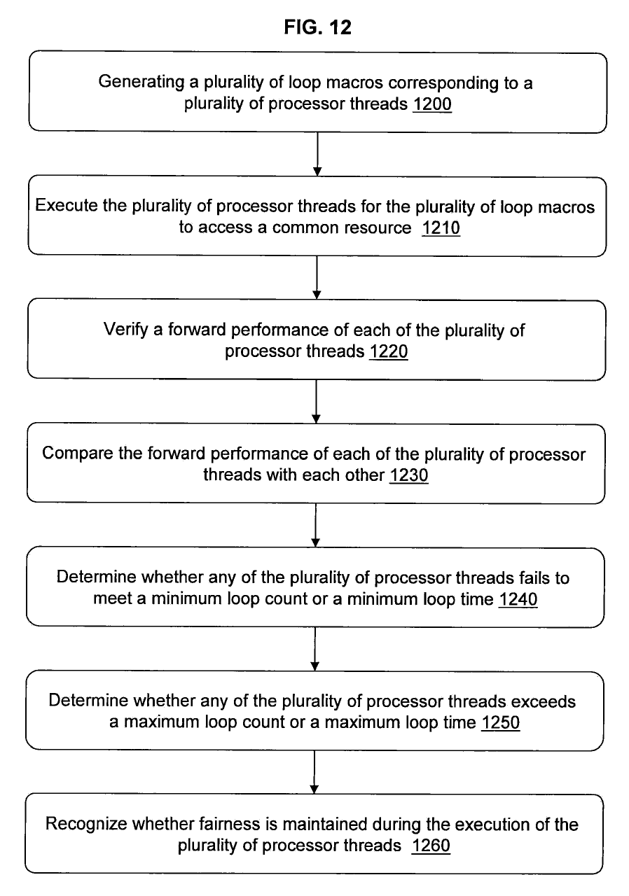

FIG. 12 illustrates a method for assessing fairness, performance, and livelock in a logic development process utilizing comparative parallel looping in accordance with exemplary embodiments. A plurality of loop macros are generated, where the plurality of loop macros respectively correspond to a plurality of processor threads and where the plurality of loops are parallel comparative loop macros at 1200.

The plurality of processor threads for the plurality of loop macros are executed, where the plurality of processor threads are executed to access a common resource at 1210. A forward performance of each of the plurality of processor threads is verified at 1220. The forward performance of each of the plurality of processor threads is compared with each other at 1230. It is determined whether any of the plurality of processor threads fails to meet a minimum loop count or a minimum loop time at 1240. It is determined whether any of the plurality of processor threads exceeds a maximum loop count or a maximum loop time at 1250. It is recognized whether fairness is maintained during the execution of the plurality of processor threads at 1260.

A loop manager directs a plurality of bus functional models to respectively generate the plurality of loop macros in accordance with predefined parameters. Also, the plurality of loop macros may be generated by receiving an input of the plurality of loop macros.

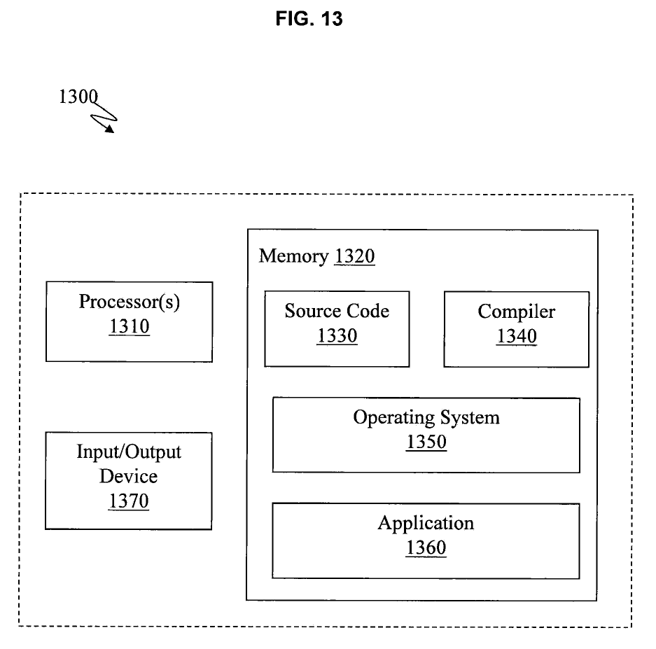

FIG. 13 illustrates an example of a computer 1300 having capabilities, which may be included in exemplary embodiments. Various methods, procedures, and techniques discussed above may also utilize the capabilities of the computer 1300. One or more of the capabilities of the computer 1300 may be incorporated in any of the element discussed herein.

Generally, in terms of hardware architecture, the computer 1300 may include one or more processors 1310, memory 1320, and one or more input and/or output (I/O) devices 1370 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 1310 is a hardware device for executing software that can be stored in the memory 1320. The processor 1310 can be virtually any custom made or commercially available processor, a central processing unit (CPU), a data signal processor (DSP), or an auxiliary processor among several processors associated with the computer 1300, and the processor 1310 may be a semiconductor based microprocessor (in the form of a microchip) or a macroprocessor.

The memory 1320 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 1320 may incorporate electronic, magnetic, optical, and/or other types of storage media. Note that the memory 1320 can have a distributed architecture, where various components are situated remote from one another, but can be accessed by the processor 1310.

The software in the memory 1320 may include one or more separate programs, each of which comprises an ordered listing of executable instructions for implementing logical functions. The software in the memory 1320 includes a suitable operating system (O/S) 1350, compiler 1340, source code 1330, and an application 1360 (which may be one or more applications) of the exemplary embodiments. As illustrated, the application 1360 comprises numerous functional components for implementing the features and operations of the exemplary embodiments. The application 1360 of the computer 1300 may represent various applications (loop macros or processor threads), but the application 1360 is not meant to be a limitation.

The operating system 1350 may control the execution of other computer programs, and provides scheduling, input-output control, file and data management, memory management, and communication control and related services.

The application 1360 may be a source program, executable program (object code), script, or any other entity comprising a set of instructions to be performed. When a source program, then the program is usually translated via a compiler (such as the compiler 1340), assembler, interpreter, or the like, which may or may not be included within the memory 1320, so as to operate properly in connection with the O/S 1350. Furthermore, the application 1360 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, NET, and the like.

The I/O devices 1370 may include input devices such as, for example but not limited to, a mouse, keyboard, scanner, microphone, camera, etc. Furthermore, the I/O devices 1370 may also include output devices, for example but not limited to, a printer, display, etc. Finally, the I/O devices 1370 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 1370 also include components for communicating over various networks, such as the Internet or an intranet.

When the computer 1300 is in operation, the processor 1310 is configured to execute software stored within the memory 1320, to communicate data to and from the memory 1320, and to generally control operations of the computer 1300 pursuant to the software. The application 1360 and the O/S 1350 are read, in whole or in part, by the processor 1310, perhaps buffered within the processor 1310, and then executed.

When the application 1360 is implemented in software it should be noted that the application 1360 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 1360 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 1360 is implemented in hardware, the application 1360 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 1300 includes non-limiting examples of software and hardware components that may be included in various devices and systems discussed herein, and it is understood that additional software and hardware components may be included in the various devices and systems discussed in exemplary embodiments.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for assessing fairness, performance, and livelock in a logic development process utilizing comparative parallel looping, comprising:
generating a plurality of loop macros, wherein the plurality of loop macros respectively correspond to a plurality of processor threads, and wherein the plurality of loops macros are parallel comparative loop macros;
executing the plurality of processor threads for the plurality of loop macros, wherein the plurality of processor threads are executed to access a common resource;
verifying a forward performance of each of the plurality of processor threads;
comparing the forward performance of each of the plurality of processor threads with each other;
determining whether any of the plurality of processor threads fails to meet a minimum loop count or a minimum loop time;
determining whether any of the plurality of processor threads exceeds a maximum loop count or a maximum loop time; and
recognizing whether fairness is maintained during the execution of the plurality of processor threads.

2. The method of claim 1, wherein a loop manager directs a plurality of bus functional models to respectively generate the plurality of loop macros in accordance with predefined parameters.

3. The method of claim 1, wherein the plurality of loop macros are generated by receiving an input of the plurality of loop macros.

4. The method of claim 1, further comprising in response to determining that any of the plurality of processor threads fails to meet the minimum loop count or the minimum loop time, recognizing that fairness is not maintained.

5. The method of claim 1, further comprising in response to determining that any of the plurality of processor threads exceeds the maximum loop count or the maximum loop time, recognizing that fairness is not maintained.

6. The method of claim 1, further comprising:
checking a number of iterations for each of the plurality of processor threads;
determining whether the number of iterations for any of the plurality of processor threads varies by more than a predefined amount; and
indicating unfairness in response to the number of iterations for any of the plurality of processor threads varying by more than the predefined amount.

7. The method of claim 1, further comprising checking a number of iterations for each of the plurality of processor threads at the completion of an iteration for any of the plurality of processor threads.

8. The method of claim 1, further comprising:
registering a plurality of bus functional models, wherein the plurality of bus functional models respectively execute the plurality of loop macros;
receiving a hot plug operation request from one of the plurality of bus function models, wherein the hot plug operation simulates removal of the one of the plurality of bus functional models;
quiescing the other plurality of bus functional models in response to the hot plug operation request;
proceeding with the hot plug operation; and
re-registering the one of the plurality of bus functional models that requested the hot plug operation.

9. An apparatus for assessing fairness, performance, and livelock in a logic development process utilizing comparative parallel looping, comprising:
memory;
a processor, functionally coupled to the memory;
a manager is configured to manage a plurality of loop macros; and
a plurality of bus functional models, each respectively associated with the plurality of loop macros;
wherein the plurality of bus functional models respectively execute the plurality of loop macros as the manager monitors the execution;
wherein the manager is configured to:
verify a forward performance of each of the plurality of loop macros being executed by the plurality of bus functional models;
compare the forward performance of each of the plurality of loop macros with each other;
determine whether any of the plurality of loop macros fails to meet a minimum loop count or a minimum loop time;
determine whether any of the plurality of loop macros exceeds a maximum loop count or a maximum loop time; and
recognize whether fairness is maintained during the execution of the plurality of loop macros.

10. The apparatus of claim 9, wherein the manager directs the plurality of bus functional models to respectively generate the plurality of loop macros in accordance with predefined parameters.

11. The apparatus of claim 9, wherein in response to any of the plurality of loop macros meeting a specific constraint, the manager stops the other loop macros of the plurality of loop macros.

12. The apparatus of claim 9, wherein in response to the manager determining that any of the plurality of loop macros fails to meet the minimum loop count or the minimum loop time, the manager recognizes that fairness is not maintained.

13. The apparatus of claim 9, wherein in response to the manager determining that any of the plurality of processor threads exceeds the maximum loop count or the maximum loop time, the manager recognizes that fairness is not maintained.

14. The apparatus of claim 9, wherein the manager:
checks a number of iterations for each of the plurality of loop macros;
determines whether the number of iterations for any of the plurality of loop macros varies by more than a predefined amount; and
indicates unfairness in response to the number of iterations for any of the plurality loop macros varying by more than the predefined amount.

15. The apparatus of claim 9, wherein the manager checks a number of iterations for each of the plurality of loop macros at the completion of an iteration for any of the plurality of loop macros.

16. The apparatus of claim 9, wherein the manger:
registers the plurality of bus functional models;
receives a hot plug operation request from one of the plurality of bus function models, wherein the hot plug operation simulates removal of the one of the plurality of bus functional models;
queisces the other plurality of bus functional models in response to the hot plug operation request;
allows the one of the bus functional models to proceed with the hot plug operation; and
re-registers the one of the plurality of bus functional models that requested the hot plug operation.

17. A computer program product, tangibly embodied on a computer readable medium, for assessing fairness, performance, and livelock in a logic development process utilizing comparative parallel looping, the computer program product including instructions for causing a computer to execute a method, comprising:
generating a plurality of loop macros, wherein the plurality of loop macros respectively correspond to a plurality of processor threads, and wherein the plurality of loop macros are parallel comparative loop macros;
executing the plurality of processor threads for the plurality of loop macros, wherein the plurality of processor threads are executed to access a common resource;
verifying a forward performance of each of the plurality of processor threads;
comparing the forward performance of each of the plurality of processor threads with each other;
determining whether any of the plurality of processor threads fails to meet a minimum loop count or a minimum loop time;
determining whether any of the plurality of processor threads exceeds a maximum loop count or a maximum loop time; and
recognizing whether fairness is maintained during the execution of the plurality of processor threads.

18. The computer program product of claim 17, wherein a loop manager directs a plurality of bus functional models to respectively generate the plurality of loop macros in accordance with predefined parameters.

19. The computer program product of claim 17, wherein the plurality of loop macros are generated by receiving an input of the plurality of loop macros.

20. The computer program product of claim 17, further comprising in response to determining that any of the plurality of processor threads fails to meet the minimum loop count or the minimum loop time, recognizing that fairness is not maintained.
